(19) United States
(12) Patent Application Publication
(10) Pub. No.: US 2026/0279616 A1
(43) Pub. Date: Sep. 17, 2026

(54) RESIN COMPOSITION, INSULATED WIRE, AND METHOD OF MANUFACTURING INSULATED WIRE

(71) Applicants: SUMITOMO ELECTRIC INDUSTRIES, LTD., Osaka-shi, Osaka (JP); SUMITOMO ELECTRIC WINTEC, INC., Koka-shi, Shiga (JP)

(72) Inventors: Masuo IIDA, Osaka-shi (JP); Shinya OTA, Osaka-shi (JP)

(73) Assignees: SUMITOMO ELECTRIC INDUSTRIES, LTD., Osaka-shi, Osaka (JP); SUMITOMO ELECTRIC WINTEC, INC., Koka-shi, Shiga (JP)

(21) Appl. No.: 19/473,295

(22) PCT Filed: Apr. 17, 2023
(86) PCT No.: PCT/JP2023/015359

§ 371 Date: Oct. 7, 2025

(51) Int. Cl. H01B 3/30; C08K 5/092; H01B 19/00

(52) U.S. Cl. CPC H01B 3/306; C08K 5/092; H01B 19/00

(57) ABSTRACT

A resin composition containing: a polyimide precursor that is a reaction product of an aromatic tetracarboxylic dianhydride and an aromatic diamine; an organic solvent; and an aliphatic polyvalent carboxylic acid ester, wherein the total number of carbon atoms in the aliphatic polyvalent carboxylic acid ester is 9 or more excluding the carbon atom of the carbonyl group.

### TECHNICAL FIELD

The present disclosure relates to a resin composition, an insulated wire, and a method of manufacturing an insulated wire.

### BACKGROUND ART

Patent Literature 1 describes an insulated wire having an insulating varnish containing a coating film constituent resin and a thermally decomposable resin that decomposes at a temperature lower than the baking temperature of the coating film constituent resin, and a heat-cured film of the insulating varnish, wherein voids based on thermal decomposition of the thermally decomposable resin are formed in the heat-cured film.

### CITATION LIST

### Patent Literature

Patent literature 1: Japanese Unexamined Patent Application Publication No. 2012-224714

### SUMMARY OF INVENTION

A resin composition according to an aspect of the present disclosure includes a polyimide precursor that is a reaction product of an aromatic tetracarboxylic dianhydride and an aromatic diamine, an organic solvent, and an aliphatic polycarboxylic acid ester. The total number of carbon atoms of the aliphatic polycarboxylic acid ester is 9 or more excluding carbon atoms of carbonyl groups.

### DETAILED DESCRIPTION

### Problems to be Solved by Present Disclosure

An object of the present disclosure is to provide a resin composition that can form an insulating coating having voids.

### Advantageous Effects of Present Disclosure

According to the resin composition according to one aspect of the present disclosure, an insulating coating having voids can be formed.

### Description of Embodiments of Present Disclosure

First, embodiments of the present disclosure will be listed and described.
Item 1.

A resin composition including:
a polyimide precursor that is a reaction product of an aromatic tetracarboxylic dianhydride and an aromatic diamine;
an organic solvent; and
an aliphatic polycarboxylic acid ester, wherein the total number of carbon atoms of the aliphatic polycarboxylic acid ester is 9 or more excluding carbon atoms of carbonyl groups.
Item 2.

The resin composition according to the above item 1, wherein the aliphatic polycarboxylic acid ester is an aliphatic dicarboxylic acid ester or an aliphatic tricarboxylic acid ester.
Item 3.

The resin composition according to the above item 1 or item 2, wherein the aliphatic polycarboxylic acid ester is derived from an aliphatic polycarboxylic acid of which the number of carbon atoms is 2 to 8 excluding the carbon atoms of the carbonyl groups.
Item 4.

The resin composition according to any one of the above item 1 to item 3, wherein the total number of carbon atoms of the aliphatic polycarboxylic acid ester is 19 or less excluding the carbon atoms of the carbonyl groups.
Item 5.

The resin composition according to any one of the above item 1 to item 4, wherein a content of the aliphatic polycarboxylic acid ester relative to 100 parts by mass of a total of the polyimide precursor and the organic solvent is 1 part by mass to 20 parts by mass. Item 6.

The resin composition according to any one of the above item 1 to item 5, wherein the organic solvent has a boiling point of 150° C. or more.
Item 7.

The resin composition according to any one of the above item 1 to item 6, further comprising thermally decomposable resin-containing particles.
Item 8.

The resin composition according to any one of the above item 1 to item 7, which is used for forming an insulating coating of an insulated wire.
Item 9.

An insulated wire including:
a conductor; and
an insulating coating covering the conductor,
wherein the insulating coating includes a resin matrix and a plurality of voids, and
the insulating coating is formed from the resin composition according to any one of the above item 1 to item 8.
Item 10.

A method of manufacturing the insulated wire according to the above item 9, the method comprising:
applying the resin composition to an outer peripheral surface of the conductor; and
heating the resin composition applied in the applying.

### Details of Embodiments of Present Disclosure

Hereinafter, a resin composition, an insulated wire, and a method of manufacturing an insulated wire according to an aspect of the present disclosure will be described.

### <Resin Composition>

The resin composition includes a polyimide precursor that is a reaction product of an aromatic tetracarboxylic dianhydride and an aromatic diamine, an organic solvent, and an aliphatic polycarboxylic acid ester. The total number of carbon atoms of the aliphatic polycarboxylic acid ester is 9 or more excluding carbon atoms of carbonyl groups.

The resin composition includes the aliphatic polycarboxylic acid ester of which the total number of carbon atoms is 9 or more excluding the carbon atoms of the carbonyl groups, and thus can form an insulating coating having voids. Although not wishing to be construed in a limiting manner, it is presumed that voids can be formed by phase separation of the polyimide precursor and the aliphatic polycarboxylic acid ester when an insulating coating is formed using the resin composition, and the balance between the hydrophobicity and hydrophilicity of the aliphatic polycarboxylic acid ester is involved in the success or failure of the formation of voids by the phase separation. It is presumed that when the total number of carbon atoms of the aliphatic polycarboxylic acid ester is 9 or more excluding the carbon atoms of the carbonyl groups, the balance between hydrophobicity and hydrophilicity is appropriate, and thus an insulating coating having voids can be formed.

The resin composition can be suitably used as a resin composition (resin varnish) for forming an insulating coating of an insulated wire.

Hereinafter, each component contained in the resin composition will be described.

### (Polyimide Precursor)

A polyimide precursor is a reaction product obtained by a polymerization condensation reaction of an aromatic tetracarboxylic dianhydride and an aromatic diamine. The polyimide precursor is a compound also referred to as polyamic acid (polyamide acid). The polyimide precursor forms a cyclic imide by a cyclodehydration reaction to become a polyimide.

When the aromatic tetracarboxylic dianhydride includes pyromellitic dianhydride (PMDA), the heat resistance of the insulating coating can be improved. This is because PMDA has a rigid and linear molecular structure.

The lower limit of the content of PMDA relative to 100 mol % of the aromatic tetracarboxylic dianhydride may be 0 mol %, 10 mol %, 20 mol %, or 30 mol %. The upper limit of the content of PMDA relative to 100 mol % of the aromatic tetracarboxylic dianhydride may be 100 mol %, 90 mol %, 80 mol %, or 70 mol %.

The aromatic tetracarboxylic dianhydride may include an aromatic tetracarboxylic dianhydride other than PMDA (hereinafter, also referred to as “other aromatic tetracarboxylic dianhydride”). Examples of the other aromatic tetracarboxylic dianhydrides include 3,3′,4,4′-biphenyltetracarboxylic dianhydride (s-BPDA), 2,3,3′,4′-biphenyltetracarboxylic dianhydride (a-BPDA), 2,2′,3,3′-biphenyltetracarboxylic dianhydride (i-BPDA), 3,3′,4,4′-benzophenonetetracarboxylic dianhydride, 4,4′-oxydiphthalic dianhydride, 2,2′,3,3′-benzophenonetetracarboxylic dianhydride, 2,2-bis(3,4-dicarboxyphenyl) propane dianhydride, 2,2-bis(2,3-dicarboxyphenyl) propane dianhydride, 1,1-bis(3,4-dicarboxyphenyl) ethane dianhydride, 1,1-bis(2,3-dicarboxyphenyl) ethane dianhydride, bis(3,4-dicarboxyphenyl) methane dianhydride, bis(2,3-dicarboxyphenyl) methane dianhydride, bis(3,4-dicarboxyphenyl) sulfone dianhydride, bis(3,4-dicarboxyphenyl) ether dianhydride, 1,2,5,6-naphthalenetetracarboxylic dianhydride, 2,3,6,7-naphthalenetetracarboxylic dianhydride. The other aromatic tetracarboxylic dianhydride may be used alone or in combination of two or more.

The content of the other aromatic tetracarboxylic dianhydride relative to 100 mol % of the aromatic tetracarboxylic dianhydride can be appropriately determined within a range not impairing the effects of the present disclosure. The upper limit of the content may be 30 mol % or 20 mol %. The lower limit of the content may be 0 mol % or 10 mol %.

When the aromatic diamine includes diaminodiphenyl ether (ODA), the heat resistance of the insulating coating can be improved. This is because ODA has a rigid and linear molecular structure. The diaminodiphenyl ethers include 4,4′-diaminodiphenyl ether (4,4′-ODA), 3,4′-diaminodiphenyl ether (3,4′-ODA), 3,3′-diaminodiphenyl ether (3,3′-ODA), 2,4′-diaminodiphenyl ether (2,4′-ODA), and 2,2′-diaminodiphenyl ether (2,2′-ODA). When 4,4′-diaminodiphenyl ether (4,4′-ODA) is used, the film elongation of the insulating coating can be improved.

The lower limit of the content of ODA relative to 100 mol % of the aromatic diamine may be 50 mol %, 60 mol %, or 70 mol %. The upper limit of the content of ODA relative to 100 mol % of the aromatic diamine may be 100 mol % or 90 mol %.

The aromatic diamine may further include an aromatic diamine other than ODA (hereinafter, also referred to as “other aromatic diamine”). Examples of the other aromatic diamine include 2,2-bis-[4-(4-aminophenoxy)phenyl]propane (BAPP), 4,4′-bis-(4-aminophenoxy) biphenyl (BAPB), 4,4′-diaminodiphenyl methane, 3,4′-diaminodiphenyl methane, 3,3′-diaminodiphenyl methane, 2,4′-diaminodiphenyl methane, 2,2′-diaminodiphenyl methane, 4,4′-diaminodiphenyl sulfone, 3,4′-diaminodiphenyl sulfone, 3,3′-diaminodiphenyl sulfone, 2,4′-diaminodiphenyl sulfone, 2,2′-diaminodiphenyl sulfone, 4,4′-diaminodiphenyl sulfide, 3,4′-diaminodiphenyl sulfide, 3,3′-diaminodiphenyl sulfide, 2,4′-diaminodiphenyl sulfide, 2,2′-diaminodiphenyl sulfide, paraphenylenediamine, metaphenylenediamine, p-xylylenediamine, m-xylylenediamine, 2,2′-dimethyl-4,4′-diaminobiphenyl (mTBHG), 1,5-diaminonaphthalene, 4,4′-benzophenonediamine, 3,3′-dimethyl-4,4′-diaminodiphenyl methane, and 3,3′,5,5′-tetramethyl-4,4′-diaminodiphenyl methane. The other aromatic diamines may be used alone or in combination of two or more.

The content of the other aromatic diamine relative to 100 mol % of the aromatic diamine can be appropriately determined within a range not impairing the effects of the present disclosure. The upper limit of the content may be 40 mol % or 30 mol %. The lower limit of the content may be 0 mol % or 10 mol %.

The polyimide precursor preferably has a glass transition temperature of 250° C. or more, as measured by the following method. The lower limit of the glass transition temperature may be 280° C. or 300° C. Although not wishing to be construed in a limiting manner, when the glass transition temperature is more than 280° C., softening of the polyimide can be reduced during formation of voids, and thus the porosity tends to be easily improved. The upper limit of the glass transition temperature is not particularly limited, and is, for example, 400° C. The resin composition was applied as a thin film onto a glass plate and heated at 350° C. for 1 hour to prepare a film-shaped test sample, and the glass-transition temperature was measured with a dynamic viscoelasticity measuring apparatus under temperature raising conditions of 1 Hz and a temperature rise rate of 10° C./min. The glass transition temperature can be adjusted by the type or the like of monomer forming the polyimide precursor.

The lower limit of the concentration of the polyimide precursor in the resin composition may be 25% by mass or 27% by mass. The upper limit of the concentration may be 40% by mass or 35% by mass. By setting the concentration to the lower limit or more, the amount of the resin composition required in the entire manufacturing process for obtaining an insulating coating having a desired thickness when forming the insulating coating using the resin composition can be reduced, and the number of times of the applying step and the heating step can be reduced. By setting the concentration to the upper limit or less, the viscosity of the resin composition can be appropriately adjusted while maintaining good film characteristics, and the applying performance can be improved.

The molar ratio of the aromatic tetracarboxylic dianhydride to the aromatic diamine (aromatic tetracarboxylic dianhydride: aromatic diamine) used as the raw materials of the polyimide precursor may be, for example, 95:105 to 105:95, 97:103 to 103:97, or 99:101 to 101:99, from the viewpoint of ease of synthesis of the polyimide precursor. The aromatic tetracarboxylic dianhydride and the aromatic diamine may be in substantially equimolar amounts. In this case, the molecular weight of the polyimide precursor can be easily increased. The term “substantially equimolar amount” means that the molar ratio of the aromatic tetracarboxylic dianhydride to the aromatic diamine (aromatic tetracarboxylic dianhydride:aromatic diamine) is in the range of 99:101 to 101:99.

### (Method of Synthesizing Polyimide Precursor)

The polyimide precursor may be obtained by a polymerization condensation reaction of the aromatic tetracarboxylic dianhydride and the aromatic diamine described above. The method of the polymerization condensation reaction may be the same as that for the conventional synthesis of a polyimide precursor. A specific method of the polymerization condensation reaction includes, for example, a method of mixing the aromatic tetracarboxylic dianhydride and the aromatic diamine in an organic solvent. By this method, the aromatic tetracarboxylic dianhydride and the aromatic diamine are polymerized, and a solution in which the polyimide precursor is dissolved in the organic solvent can be obtained. For example, the polymerization degree (weight average molecular weight) can be controlled by performing the polymerization condensation reaction in the presence of a reaction control agent.

Examples of the reaction control agent include water (H₂O) and alcohols of which the number of carbon atoms is 1 to 15 Examples of the alcohol of which the number of carbon atoms is 1 to 15 include monohydric alcohols such as ethanol, methanol, propanol, butanol, and pentanol; and polyhydric alcohols such as ethylene glycol, propylene glycol, and glycerin.

The reaction conditions for the polymerization may be appropriately set depending on the raw materials used and the like. For example, the reaction temperature may be 10° C. to 100° C., and the reaction time may be 0.5 hours to 24 hours.

Examples of the organic solvent used in the polymerization condensation reaction include similar organic solvents as those described below.

### (Organic Solvent)

Examples of the organic solvent include an aprotic polar organic solvent such as N-methyl-2-pyrrolidone (NMP, boiling point: 202° C.), N,N-dimethylacetamide (DMAc, boiling point: 165° C.), N,N-dimethylformamide (boiling point: 153° C.), dimethyl sulfoxide (boiling point: 189° C.), and γ-butyrolactone (boiling point: 204° C.). The organic solvent may be used alone or in combination of two or more. The term “aprotic polar organic solvent” refers to a polar organic solvent that does not have a group that releases a proton.

When the boiling point of the organic solvent is 150° C. or more, unintended drying before baking in the process of forming the insulating coating can be prevented.

The content of the organic solvent is not particularly limited as long as it is within an amount that can uniformly dissolve or disperse the aromatic tetracarboxylic dianhydride and the aromatic diamine. If the content is too large, however, a large amount of the organic solvent needs to be volatilized when forming the insulating coating of the insulated wire, which may require a long time to form the insulating coating. Thus, the content of the organic solvent may be, for example, 100 parts by mass to 1,000 parts by mass relative to 100 parts by mass of the total of the aromatic tetracarboxylic dianhydride and the aromatic diamine.

### (Aliphatic Polycarboxylic Acid Ester)

The total number of carbon atoms of the aliphatic polycarboxylic acid ester is 9 or more excluding carbon atoms of carbonyl groups. The term “the number of carbon atoms” means the number of carbon atoms forming a compound or a functional group. The term “aliphatic polycarboxylic acid ester” means an ester derived from aliphatic polycarboxylic acid. The term “aliphatic polycarboxylic acid” means an aliphatic carboxylic acid having two or more carboxy groups. The term “carboxylic acid” means a compound having a carboxy group, and includes not only carboxylic acids in a narrow sense but also carboxylic acids in a broad sense such as hydroxycarboxylic acids. The term “the total number of carbon atoms is 9 or more excluding the carbon atoms of the carbonyl groups” means that the number of carbon atoms excluding the carbon atoms of the carbonyl groups from the total number of carbon atoms forming the aliphatic polycarboxylic acid ester (hereinafter, also simply referred to as “the total number of carbon atoms”) is 9 or more.

When the total number of carbon atoms of the aliphatic polycarboxylic acid ester is 9 or more, an insulating coating having voids can be formed.

The lower limit of the total number of carbon atoms is 9, and may be 10, 11, or 12. The upper limit of the total number of carbon atoms may be 30, 20, 19, 18, 17, or 16. When the total number of carbon atoms is 19 or less, the balance between the hydrophobicity and hydrophilicity of the aliphatic polycarboxylic acid ester is further improved, and thus the stability of the resin composition can be enhanced.

Examples of the aliphatic polycarboxylic acid ester include aliphatic dicarboxylic acid ester, aliphatic tricarboxylic acid ester, and aliphatic tetracarboxylic acid ester, as classified according to the number of carboxy groups. When the aliphatic polycarboxylic acid ester is the aliphatic dicarboxylic acid ester or the aliphatic tricarboxylic acid ester, the molecular weight is small and the boiling point and the thermal decomposition temperature are low as compared with an aliphatic polycarboxylic acid having four or more carboxyl groups (for example, an aliphatic tetracarboxylic acid ester), and thus the residual amount in the insulating coating can be reduced. By reducing the amount of the aliphatic dicarboxylic acid ester remaining in the insulating coating, the relative permittivity of the insulating coating can be reduced.

When the aliphatic polycarboxylic acid ester is derived from an aliphatic polycarboxylic acid of which the number of carbon atoms is 2 to 8 excluding carbon atoms of carbonyl groups, the hydrophobicity of the aliphatic polycarboxylic acid ester becomes appropriate, and thus the dispersibility in the resin composition can be improved. Furthermore, compared to the case where the aliphatic polycarboxylic acid ester is derived from an aliphatic polycarboxylic acid of which the number of carbon atoms is 9 or more excluding carbon atoms of carbonyl groups, the molecular weight is smaller and the boiling point and the thermal decomposition temperature are lower, and thus the residual amount in the insulating coating can be reduced.

Examples of the aliphatic polycarboxylic acid ester include a compound represented by the following formula (1).

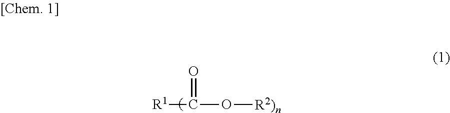

In the above formula (1), R¹ represents a substituted or unsubstituted n-valent aliphatic hydrocarbon group. R² represents a substituted or unsubstituted monovalent aliphatic hydrocarbon group, n is an integer of 2 or more, and (the number of carbon atoms in R¹)+n×(the number of carbon atoms in R²) is 9 or more.

The “valency” of a group refers to the number of atoms to which the group is attached. The “aliphatic hydrocarbon group” includes a “chain hydrocarbon group” and an “alicyclic hydrocarbon group”. From another viewpoint, the “aliphatic hydrocarbon group” includes a “saturated hydrocarbon group” and an “unsaturated hydrocarbon group”. The “chain hydrocarbon group” refers to a hydrocarbon group that does not include a ring structure and is constituted only by a chain structure, and includes both a linear hydrocarbon group and a branched hydrocarbon group. The “alicyclic hydrocarbon group” refers to a hydrocarbon group containing only an alicyclic ring as a ring structure and not containing an aromatic ring, and includes both monocyclic alicyclic hydrocarbon groups and polycyclic alicyclic hydrocarbon groups. However, alicyclic hydrocarbon group is not necessarily constituted only by an alicyclic ring, and a chain structure may be contained in a part thereof.

In the above formula (1), the total of the number of carbon atoms in R¹ and n times the number of carbon atoms in R² ((the number of carbon atoms in R¹)+n×(the number of carbon atoms in R²)) corresponds to the above total number of carbon atoms. More specifically, for example, when the aliphatic polycarboxylic acid ester is dibutyl adipate (a compound represented by the following formula (2)), the above total number of carbon atoms is 12. In dibutyl adipate, the number of carbon atoms of the structure corresponding to R¹ in the above formula (1) is 4, the number of carbon atoms of the structure corresponding to R² is 4, and n is 2, and thus the total number of carbon atoms is 4+2×4=12. In addition, for example, diethyl adipate (a compound represented by the following formula (3)) has the total number of carbon atoms of 8, and thus does not correspond to the aliphatic polycarboxylic acid ester. In diethyl adipate, the number of carbon atoms of the structure corresponding to R¹ in the above formula (1) is 4, the number of carbon atoms of the structure corresponding to R² is 2, and n is 2, and thus the total number of carbon atoms is 4+2× 2=8.

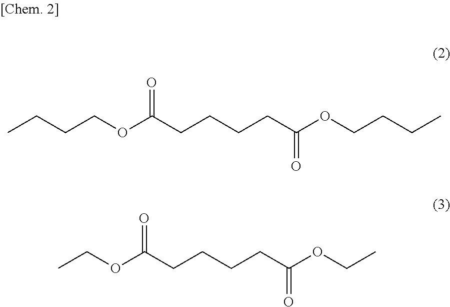

Examples of R¹ in the above formula (1) include a group obtained by removing (n−1) hydrogen atoms from the monovalent aliphatic hydrocarbon group in R² described below.

Examples of R² in the above formula (1) include a monovalent aliphatic hydrocarbon group of which the number of carbon atoms is 1 to 20. Examples of the monovalent aliphatic hydrocarbon group of which the number of carbon atoms is 1 to 20 include a monovalent chain hydrocarbon group of which the number of carbon atoms is 1 to 20 and a monovalent alicyclic hydrocarbon group of which the number of carbon atoms is 3 to 20.

Examples of the monovalent chain hydrocarbon group of which the number of carbon atoms is 1 to 20 include alkyl groups such as a methyl group, an ethyl group, an n-propyl group, an i-propyl group, an n-butyl group, a sec-butyl group, an isobutyl group, and a tert-butyl group; alkenyl groups such as an ethenyl group, a propenyl group, a butenyl group, and a 2-methylprop-1-en-1-yl group; and alkynyl groups such as an ethynyl group, a propynyl group, and a butynyl group.

Examples of the monovalent alicyclic hydrocarbon group of which the number of carbon atoms is 3 to 20 include monocyclic alicyclic saturated hydrocarbon groups such as a cyclopentyl group and a cyclohexyl group; polycyclic alicyclic saturated hydrocarbon groups such as a norbornyl group, an adamantyl group, a tricyclodecyl group, and a tetracyclododecyl group; monocyclic alicyclic unsaturated hydrocarbon groups such as a cyclopentenyl group and a cyclohexenyl group; and polycyclic alicyclic unsaturated hydrocarbon groups such as a norbornenyl group, a tricyclodecenyl group, and a tetracyclododecenyl group.

The aliphatic hydrocarbon group which gives R¹ or R² may have substituents. Examples of the substituent include a halogen atom, a hydroxy group, a carboxy group, a cyano group, a nitro group, an alkoxy group, an alkoxycarbonyl group, an alkoxycarbonyloxy group, an acyl group, and an acyloxy group.

R¹ may be an n-valent aliphatic hydrocarbon group of which the number of carbon atoms is 2 to 8 or may be an n-valent chain hydrocarbon group of which the number of carbon atoms is 2 to 8. When the number of carbon atoms of R¹ is 3 or more, the porosity of the insulating coating can be improved.

R² may be a monovalent aliphatic hydrocarbon group of which the number of carbon atoms is 1 to 4, a monovalent chain hydrocarbon group of which the number of carbon atoms is 1 to 4, or an alkyl group of which the number of carbon atoms is 1 to 4.

n may be 2 or more, and may be 2, 3, or 4.

(the number of carbon atoms in R¹)+n×(the number of carbon atoms in R²) is synonymous with the total number of carbon atoms.

Examples of the aliphatic dicarboxylic acid ester include aliphatic dicarboxylic acid esters such as dibutyl fumarate, dibutyl succinate, diethyl sebacate, diisobutyl adipate, dibutyl adipate, dibutyl sebacate, and di (2-butoxyethyl) adipate, and citric acid-based esters such as triethyl citrate, triethyl O-acetylcitrate, tributyl citrate, and tributyl O-acetylcitrate. When the aliphatic dicarboxylic acid ester and the citric acid-based ester are compared, the citric acid-based ester tends to be able to form an insulating coating having a higher porosity when the total numbers of carbon atoms are the same.

The content of the aliphatic polycarboxylic acid ester in the resin composition can be appropriately set within a range in which the effects of the present disclosure are exhibited. The upper limit of the content of the aliphatic polycarboxylic acid ester may be 20 parts by mass, 18 parts by mass, 15 parts by mass, 12 parts by mass, 10 parts by mass, or 9 parts by mass, relative to 100 parts by mass of the total of the polyimide precursor and the organic solvent. When the content is 20 parts by mass or less, the insulating formed coating has a good shape without foaming in appearance. Although not wishing to be construed in a limiting manner, it is presumed that when the content is 20 parts by mass or less, the balance between the island portion and the sea portion of the sea-island structure generated by the phase separation of the polyimide precursor and the aliphatic polycarboxylic acid ester is appropriately adjusted, and thus the occurrence of appearance defects such as foaming, swelling, and peeling of the insulating coating can be reduced. The lower limit of the aliphatic polycarboxylic acid ester may be 1 part by mass, 2 parts by mass, 4 parts by mass, or 6 parts by mass, relative to 100 parts by mass of the total of the polyimide precursor and the organic solvent.

### (Thermally Decomposable Resin-Containing Particles)

When the resin composition further contains thermally decomposable resin-containing particles, an insulating coating having a good appearance can be formed even when the porosity is high. The thermally decomposable resin-containing particles are gasified by thermal decomposition, and voids are formed in the insulating coating at portions where the thermally decomposable resin-containing particles were present. In this case, the thermally decomposable resin-containing particles can be uniformly distributed as island phases of fine particles in a sea phase of a resin matrix forming the insulating coating, and independent voids can be formed.

The thermally decomposable resin contained in the thermally decomposable resin-containing particles is preferably a resin that is thermally decomposed at a temperature lower than the baking temperature of the polyimide as the main component of the resin matrix of the insulating coating. The baking temperature is appropriately set depending on the type of polyimide, and is usually about 200° C. to 600° C. The thermal decomposition temperature means a temperature at which the mass reduction rate reaches 50% when the temperature is raised from room temperature at 10° C./min under an air atmosphere. The thermal decomposition temperature can be measured by measuring the thermal weight using a thermogravimetry-differential thermal analyzer (“TG/DTA” of SII NanoTechnology Inc.).

Examples of the thermally decomposable resin include compounds in which one or both ends or a portion of polyethylene glycol or polypropylene glycol is alkylated, (meth)acrylated, or epoxidized, polymers of (meth)acrylic acid ester with an alkyl group of which the number of carbon atoms is 1 to 6, such as poly(methyl (meth)acrylate), poly(ethyl (meth)acrylate), poly(propyl (meth)acrylate), and poly(butyl (meth)acrylate), urethane oligomers, urethane polymers, modified (meth)acrylate polymers, such as urethane (meth)acrylates, epoxy (meth)acrylates, and ¿-caprolactone (meth)acrylates, poly(meth)acrylic acid, cross-linked products thereof, polystyrene, and cross-linked polystyrene. When the polymer of (meth)acrylates with an alkyl group of which the number of carbon atoms is 1 to 6 are easily thermally decomposed at the baking temperature, and voids are easily formed in the insulating coating. Examples of the polymer of-(meth)acrylic acid ester include polymethyl methacrylate (PMMA). The expression (meth)acrylic acid encompasses both “acrylic acid” and “methacrylic acid”.

The thermally decomposable resin-containing particles may be particles composed only of the thermally decomposable resin, or may be particles having a core-shell structure having a core composed mainly of the thermally decomposable resin and a shell composed mainly of a resin having a higher thermal decomposition temperature than the thermal decomposition temperature of the thermally decomposable resin. In the case of particles having a core-shell structure, the voids can be unlikely to communicate with each other, and the variation in the size of the voids can be reduced.

The main component of the shell is not particularly limited as long as it is a material having a higher thermal decomposition temperature than the core, and is preferably a synthetic resin having a low relative permittivity and high heat resistance. Examples include polystyrene, silicone, fluorine resin, and polyimide. In the case of silicone, elasticity is easily enhanced, and thus dispersibility of voids in the insulating coating is easily improved, and insulation properties and heat resistance are excellent.

### (Other Components)

The resin composition may contain other components in addition to the above components. The other components are not particularly limited as long as they are additives to be blended in a resin varnish for forming an insulating coating of an insulated wire, and examples thereof include a filler, an antioxidant, a rebephosphorus agent, a curing agent, and an adhesion aid.

### <Insulated Wire>

The insulated wire includes a conductor and an insulating coating covering the conductor. The insulated wire can be suitably used as a coil winding (magnet wire).

### (Conductor)

The conductor is usually composed mainly of a metal. The metal is not particularly limited, and when the metal is copper, copper alloy, aluminum, or aluminum alloy, an insulated wire having both good workability and conductivity can be obtained. The conductor may contain other components such as known additives in addition to the metal as the main component

The cross-sectional shape of the conductor is not particularly limited, and various shapes such as a circle, a square, and a rectangle can be adopted. The size of the cross section of the conductor is not particularly limited, and the diameter (short side width) may be, for example, 0.2 mm to 8.0 mm.

### (Insulating Coating)

The insulating coating is laminated on a circumferential surface of the conductor to cover the conductor. The insulating coating may directly or indirectly cover the conductor. Examples of the indirect covering include a multilayer structure in which the covering layer of the conductor includes a layer other than the insulating coating.

The insulating coating is formed of the resin composition described above. Thus, the insulating coating has a plurality of voids.

The average thickness of the insulating coating is not particularly limited, and is usually 2 μm to 200 μm.

The insulated wire may further include another layer laminated on the outer peripheral surface of the insulating coating. Examples of the other layer include a surface lubricating layer.

The lower limit of the porosity in the insulating coating may be 10 volume %, 15 volume %, 20 volume %, 25 volume %, or 30 volume %. The upper limit of the porosity may be 70 volume %, 60 volume %, 50 volume %, or 40 volume %. The term “porosity” means the percentage of the volume of voids to the volume of the insulating coating including voids.

When the thermally decomposable resin-containing particles are the particles having a core-shell structure, the voids have an outer shell derived from the shell of the particles having a core-shell structure at the peripheral portion.

The insulating coating may contain other components in addition to the above components. The other components are not particularly limited as long as they are additives blended in the insulating coating of the insulated wire, and examples thereof include a filler, an antioxidant, a rebephosphorus agent, a curing agent, and an adhesion aid.

### <Method of Manufacturing Insulated Wire>

The insulated wire can be manufactured by a method including, for example, a step of applying the resin composition to an outer peripheral surface of the conductor (hereinafter referred to as “applying step”) and a step of heating the resin composition applied to the conductor (hereinafter referred to as “heating step”).

In the applying step, the resin composition is applied to the outer peripheral surface of the conductor. Examples of the method of applying the resin composition to the outer peripheral surface of the conductor include a method using an applying apparatus including a liquid composition tank storing the resin composition and an applying die. According to this applying apparatus, the conductor is inserted into the liquid composition tank, whereby the resin composition adheres to the outer peripheral surface of the conductor, and then the conductor passes through the applying die, whereby the resin composition is applied with a uniform thickness.

In the heating step, the resin composition applied to the conductor in the applying step is heated. By this heating, the solvent in the resin composition is volatilized, and the polyimide precursor is cured to form polyimide.

The apparatus used in the heating step is not particularly limited, and for example, a cylindrical baking furnace that is long in the running direction of the conductor can be used. The heating method is not particularly limited, and the heating can be performed by a conventionally known method such as hot air heating, infrared heating, or high-frequency heating.

The heating temperature may be, for example, 300° C. to 800° C. The heating time may be, for example, 5 seconds to 1 minute.

The applying step and the heating step are usually repeated a plurality of times. The thickness of the insulating coating can be increased by the applying step and the heating step a plurality of times. The hole diameter of the applying die can be appropriately adjusted according to the number of repetitions.

### Other Embodiments

The embodiments disclosed herein are to be considered in all respects as illustrative and not restrictive. The scope of the present invention is not limited to the configurations of the above embodiments, but is defined by the scope of the claims, and is intended to include all modifications within the meaning and scope equivalent to the scope of the claims.

### EXAMPLES

The present invention will be described in more detail with reference to the following examples. The present invention is not limited to these examples.

### Test Example 1

In Test Example 1, the influence of the type of aliphatic polycarboxylic acid ester on the formation of voids was tested.

### [No. 1]

### (Preparation of Resin Composition)

4,4′-diaminodiphenyl ether (ODA) as aromatic diamine was dissolved in N-methyl-2-pyrrolidone (NMP). Pyromellitic dianhydride (PMDA) as aromatic tetracarboxylic dianhydride was added so that the mixing ratio (molar ratio) of aromatic tetracarboxylic dianhydride and aromatic diamine was 100:100. The mixture was reacted at 30° C. for 3 hours while being stirred under a nitrogen atmosphere to synthesize a polyimide precursor, thereby obtaining a polyimide precursor solution using NMP as a solvent (solid content concentration: 28% by mass). To 100 parts by mass of the polyimide precursor solution, 7.97 parts by mass of diethyl adipate was added to prepare a resin composition No. 1.

### [No. 2 to No. 13]

Resin compositions No. 2 to No. 13 were prepared in the same manner as No. 1 except that aliphatic polycarboxylic acid esters of the types and contents shown in Table 1 below were used.

### <Evaluation>

The resin compositions No. 1 to No. 13 prepared above were subjected to a film whitening test according to the following method. Further, insulated wires were produced from some resin compositions among the resin compositions in which whitening was observed in the film whitening test, and the porosity was measured according to the following method. The results are shown in Table 1 below.

### [Film Whitening Test]

The resin compositions No. 1 to No. 13 prepared above were subjected to a film whitening test. Specifically, each resin composition was applied to a copper foil at intervals of 200 μm, and heated at 350° C. for 1 hour under the condition of an oxygen concentration of 1% or less to prepare a film. The evaluation criteria of the film whitening test are as follows. A: Whitening was observed in the film. B: Whitening was not observed in the film.

The film whitening test is a simple test for the presence or absence of voids formation, and it can be determined that voids are formed when whitening is confirmed in the film (the film is opaque), and voids are not formed when whitening is not confirmed (the film is transparent).

### [Production of Insulated Wire and Measurement of Porosity]

### (Production of Insulated Wire)

A copper wire having a round shape with an average diameter of 1 mm was used as the conductor. The resin compositions No. 4, No. 7, No. 8, and No. 10 to No. 13 were applied to the surfaces of the conductors. The conductors applied with the resin compositions were heated in a heating furnace under the conditions of an inlet temperature of 400° C., an outlet temperature of 450° C., and a wire speed of 3 m/min, and this process was repeated 10 times to form insulating coatings having a mean thickness of 35 μm, thereby producing insulated wires.

### (Measurement of Porosity)

For the insulated wire produced above, the insulating coating was peeled off in a tubular shape from the conductor, and the mass W2 of the insulating coating having a cylindrical shape was measured. The apparent volume V1 was determined from the outer shape of the insulating coating having a cylindrical shape, and the volume V1 was multiplied by the density ρ1 of the insulating coating to calculate the mass W1 in the case where there were no voids. From these values of W1 and W2, porosity (unit: volume %) was calculated by the following Equation 1. Equation 1: Porosity=(W1−W2)×100/W1

In Table 1 below, “R¹”, “R²”, and “n” represent the number of carbon atoms of the corresponding structure in the above-described equation (1). The “total number of carbon atoms” means a number obtained by excluding the number of carbon atoms of the carbonyl groups from the total number of carbon atoms in the aliphatic polycarboxylic acid ester (i.e., (the number of carbon atoms in R¹)+n×(the number of carbon atoms in R²)). The “blending amount (parts by mass)” means the content of the aliphatic polycarboxylic acid ester relative to 100 parts by mass (total of 100 parts by mass of the polyimide precursor and the organic solvent) of the polyimide precursor solution in the resin composition. The symbol “-” in the column of “porosity (volume %)” indicates that the insulated wire was not produced and the porosity was not measured.

TABLE 1

| | Aliphatic polycarboxylic acid ester | | | | | | | |
|---|---|---|---|---|---|---|---|---|
| | | | | | | Blending | | |
| | | | | | Total number | amount | Evaluation | |
| | | | | | of carbon | (parts by | Whitening | Porosity |
| | Type | R¹ | R² | n | atoms | mass) | test | (volume %) |
| No. 1 | Diethyl adipate | 4 | 2 | 2 | 8 | 7.97 | B | — |
| No. 2 | Dimethyl suberate | 6 | 1 | 2 | 8 | 8.05 | B | — |
| No. 3 | Dibutyl fumarate | 2 | 4 | 2 | 10 | 7.81 | A | — |
| No. 4 | Dibutyl succinate | 2 | 4 | 2 | 10 | 7.73 | A | 12.3 |
| No. 5 | Diethyl sebacate | 8 | 2 | 2 | 12 | 7.65 | A | — |
| No. 6 | Diisobutyl adipate | 4 | 4 | 2 | 12 | 7.49 | A | — |
| No. 7 | Dibutyl adipate | 4 | 4 | 2 | 12 | 7.57 | A | 19.4 |
| No. 8 | Dibutyl sebacate | 8 | 4 | 2 | 16 | 7.41 | A | 22.5 |
| No. 9 | Di (2-butoxyethyl) adipate | 4 | 6 | 2 | 16 | 7.89 | A | — |
| No. 10 | Triethyl citrate | 3 | 2 | 3 | 9 | 8.99 | A | 16.3 |
| No. 11 | Triethyl 0-acetylcitrate | 4 | 2 | 3 | 10 | 8.99 | A | 19.1 |
| No. 12 | Tributyl citrate | 3 | 4 | 3 | 15 | 8.20 | A | 26.3 |
| No. 13 | Tributyl 0-acetylcitrate | 4 | 4 | 3 | 16 | 8.28 | A | 23.7 |

Table 1 shows that whitening was observed in the films when the resin compositions No. 3 to No. 13 were used, whereas whitening was not observed in the films when the resin compositions No. 1 and No. 2 were used. Thus, it can be seen that voids can be formed when the total number of carbon atoms of the aliphatic polycarboxylic acid ester is 9 or more.

Further, it can be seen from Table 1 that in the resin compositions No. 4, No. 7, No. 8, and No. 10 to No. 13, an insulating coating having a porosity of 12 volume % or more can be actually formed.

1. A resin composition comprising:
a polyimide precursor that is a reaction product of an aromatic tetracarboxylic dianhydride and an aromatic diamine;
an organic solvent; and
an aliphatic polycarboxylic acid ester,
wherein the total number of carbon atoms of the aliphatic polycarboxylic acid ester is 9 or more excluding carbon atoms of carbonyl groups.

2. The resin composition according to claim 1, wherein the aliphatic polycarboxylic acid ester is an aliphatic dicarboxylic acid ester or an aliphatic tricarboxylic acid ester.

3. The resin composition according to claim 1, wherein the aliphatic polycarboxylic acid ester is derived from an aliphatic polycarboxylic acid of which the number of carbon atoms is 2 to 8 excluding the carbon atoms of the carbonyl groups.

4. The resin composition according to claim 1, wherein the total number of carbon atoms of the aliphatic polycarboxylic acid ester is 19 or less excluding the carbon atoms of the carbonyl groups.

5. The resin composition according to claim 1, wherein a content of the aliphatic polycarboxylic acid ester relative to 100 parts by mass of a total of the polyimide precursor and the organic solvent is 1 part by mass to 20 parts by mass.

6. The resin composition according to claim 1, wherein the organic solvent has a boiling point of 150° C. or more.

7. The resin composition according to claim 1, further comprising thermally decomposable resin-containing particles.

8. The resin composition according to claim 1, which is used for forming an insulating coating of an insulated wire.

9. An insulated wire comprising:
a conductor; and
an insulating coating covering the conductor,
wherein the insulating coating includes a resin matrix and a plurality of voids,
and
the insulating coating is formed from the resin composition according to claim 1.

10. A method of manufacturing the insulated wire according to claim 9, the method comprising:
applying the resin composition to an outer peripheral surface of the conductor; and
heating the resin composition applied in the applying.

11. The resin composition according to claim 2, wherein the aliphatic polycarboxylic acid ester is an aliphatic dicarboxylic acid ester or an aliphatic tricarboxylic acid ester.

12. The resin composition according to claim 3, wherein the aliphatic polycarboxylic acid ester is an aliphatic dicarboxylic acid ester or an aliphatic tricarboxylic acid ester.

13. The resin composition according to claim 4, wherein the aliphatic polycarboxylic acid ester is an aliphatic dicarboxylic acid ester or an aliphatic tricarboxylic acid ester.

14. The resin composition according to claim 5, wherein the aliphatic polycarboxylic acid ester is an aliphatic dicarboxylic acid ester or an aliphatic tricarboxylic acid ester.

15. The resin composition according to claim 6, wherein the aliphatic polycarboxylic acid ester is an aliphatic dicarboxylic acid ester or an aliphatic tricarboxylic acid ester.

16. The resin composition according to claim 7, wherein the aliphatic polycarboxylic acid ester is an aliphatic dicarboxylic acid ester or an aliphatic tricarboxylic acid ester.

17. The resin composition according to claim 8, wherein the aliphatic polycarboxylic acid ester is an aliphatic dicarboxylic acid ester or an aliphatic tricarboxylic acid ester.

18. The resin composition according to claim 2, wherein the aliphatic polycarboxylic acid ester is derived from an aliphatic polycarboxylic acid of which the number of carbon atoms is 2 to 8 excluding the carbon atoms of the carbonyl groups.

19. The resin composition according to claim 3, wherein the aliphatic polycarboxylic acid ester is derived from an aliphatic polycarboxylic acid of which the number of carbon atoms is 2 to 8 excluding the carbon atoms of the carbonyl groups.

20. The resin composition according to claim 4, wherein the aliphatic polycarboxylic acid ester is derived from an aliphatic polycarboxylic acid of which the number of carbon atoms is 2 to 8 excluding the carbon atoms of the carbonyl groups.
